(19) United States
(12) Patent Application Publication
(10) Pub. No.: US 2015/0002480 A1
(43) Pub. Date: Jan. 1, 2015

(54) Inductive Touch Pen Structure

(71) Applicants: Ying-Da Chen, Taipei City (TW); Ching-Fang Tsao, Taipei City (TW); Chih-Shiang Tsao, Taipei City (TW)

(72) Inventors: Ying-Da Chen, Taipei City (TW); Ching-Fang Tsao, Taipei City (TW); Chih-Shiang Tsao, Taipei City (TW)

(21) Appl. No.: 13/929,769

(22) Filed: Jun. 27, 2013

(51) Int. Cl. G06F 3/0354

(52) U.S. Cl. CPC G06F 3/03545
USPC 345/179

(57) ABSTRACT

An inductive touch pen structure applied in an electronic product with a screen includes a main body having an upper casing and a lower casing coupled with each other, a touch head selectively installed at an end of the upper casing or the lower casing of the main body and at least one near field communication (NFC) module being a thin plate installed on the main body. With the structure, the main body with the NFC module can use a high-frequency wireless communication technology to open a built-in application program by a non-contact method.

### FIELD OF THE INVENTION

The present invention relates to a touch pen structure, in particular to an inductive touch pen structure having a main body with a near field communication (NFC) module and using a high-frequency wireless communication technology to open a built-in application program by a non-contact method.

### BACKGROUND OF THE INVENTION

As a mobile phone with a NFC function can provide a plurality of modes such as reading, writing, and node-to-node or card sensing, such mobile phone can bring tremendous convenience to users. However, a conventional touch pen allows user to slide on the mobile phone with the NFC function to select an open, and users have to use the touch pen to touch a screen of the mobile phone and search for a desired option from pages of the screen before touching a desired option to execute the option. Obviously, such arrangement is very inconvenient. Although some related manufacturers designed a slot on a side of the mobile phone for receiving and storing the touch pen, the user has to remove the touch pen from the slot of the mobile phone before its use. An application program (such as the directory program) with built-in personal records of the mobile phone can be used only after the touch pen is detached from the mobile phone. However, the user may not need the built-in application program for every time of using the touch pen, so that the user has to terminate the pop-up built-in application program by the touch pen. The built-in application program cannot be opened according to the user's need, and thus causing tremendous inconvenience. If the pop-up built-in application program is not terminated, it will occupy a very large memory space and a large portion of the screen, so that the practicality is reduced significantly. A breakthrough to overcome the aforementioned problem is long wanted by related manufacturers and consumers, so that the inventor of the present invention designed and developed an inductive touch pen structure having a main body with a NFC module and using the high-frequency wireless communication technology to open a built-in application program of an electronic product with the NFC function by a non-contact method.

### SUMMARY OF THE INVENTION

In view of the aforementioned shortcomings of the conventional touch pens, it is a primary objective of the present invention to overcome the shortcomings by providing an inductive touch pen structure capable of using a high-frequency wireless communication technology to open a built-in application program by a non-contact method.

Another objective of the present invention is to provide an inductive touch pen structure to improve the convenience of use effectively.

Since the problems to be solved by the present invention resides on that a mobile phone with the NFC function provides several modes of reading/writing, node-to-node or card sensing function and tremendous convenience to users. However, the mobile phone with the NFC function requires a touch pen to touch a screen of the mobile phone to select an option by sliding the touch pen on the screen of the mobile phone. In general, a user has to go through plural levels to search for the right icon before touching the icon to select an option. Obviously, such operation is very inconvenient and time-consuming. Furthermore, the use of the touch pen also causes inconvenience. Although some related manufacturers designed a slot on a side of the mobile phone for receiving and storing the touch pen, the user has to remove the touch pen from the slot of the mobile phone before its use. An application program (such as the directory program) with built-in personal records of the mobile phone can be used only after the touch pen is detached from the mobile phone. However, the user may not need the built-in application program for every time of using the touch pen, so that the user has to terminate the pop-up built-in application program by the touch pen. The built-in application program cannot be opened according to the user's need, and thus causing tremendous inconvenience. If the pop-up built-in application program is not terminated, it will occupy a very large memory space and a large portion of the screen, so that the practicality is reduced significantly.

To achieve the aforementioned objective, the present invention provides an inductive touch pen structure applied in an electronic product with a screen. The inductive touch pen structure comprises a main body having an upper casing and a lower casing coupled with each other, a touch head selectively installed at an end of the upper casing or the lower casing of the main body and at least one near field communication (NFC) module being a thin plate installed on the main body. With the structure, the main body with the NFC module can use a high-frequency wireless communication technology to open a built-in application program by a non-contact method.

The inductive touch pen structure further comprises a pen clip disposed on the main body, and the pen clip is an elastic member with an inner side of an end attached to the main body.

Preferably the pen clip is installed at the upper casing or the lower casing.

Preferably, the upper casing is a non-conductive upper casing or a conductive upper casing.

Preferably, the lower casing is a conductive lower casing or a non-conductive lower casing.

Preferably, the touch head is installed at a conductive upper casing or a conductive lower casing.

Preferably, the NFC module is installed at the non-conductive upper casing or the non-conductive lower casing.

Preferably, the electronic product with the screen is a mobile phone with the NFC function, a tablet PC with the NFC function, or an electronic product with the NFC function.

With the structure, the main body with the NFC module can use a high-frequency wireless communication technology to open a built-in application program by a non-contact method. The invention provides a convenience application and improves over the prior art.

### BRIEF DESCRIPTION OF THE DRAWINGS

FIG. 1 is an exploded view of the present invention;

FIG. 2 is a perspective view of the present invention;

FIG. 3 is a sectional view of the present invention;

FIG. 4 is a schematic view of a touch pen held by a user's hand and not approaching a screen of an electronic product in accordance with the present invention;

FIG. 5 is a schematic view of a touch pen held by a user's hand and approaching a screen of an electronic product in accordance with the present invention; and

FIG. 6 is a schematic view of a touch pen clipped onto a pocket of a user's clothes in accordance with the present invention.

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

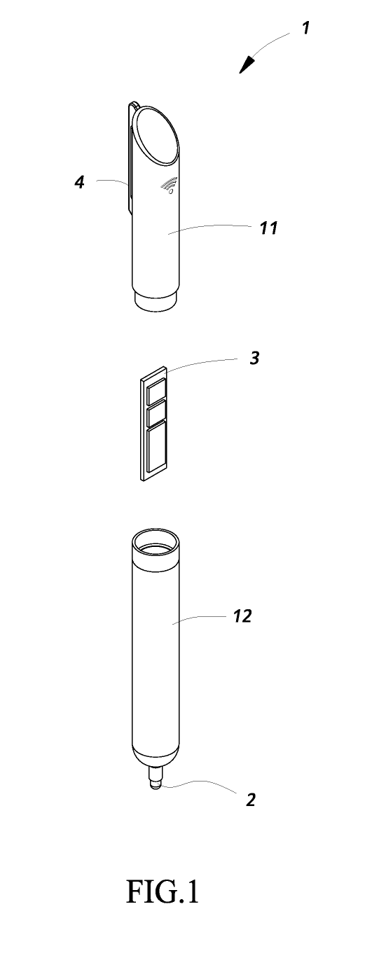

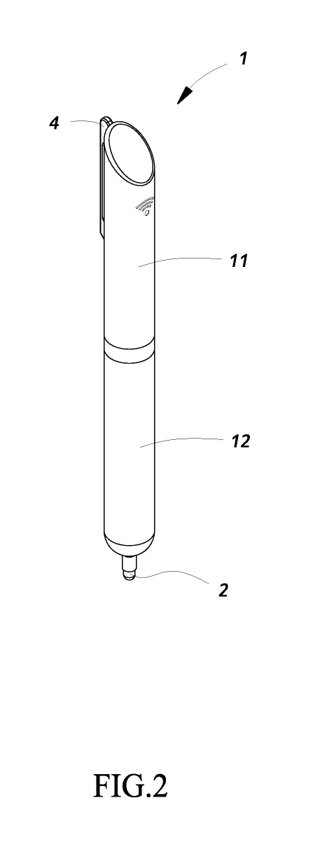

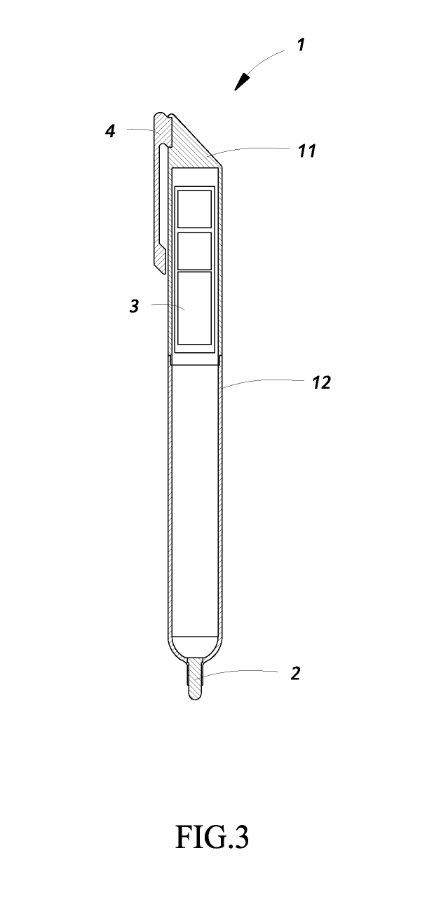

With reference to FIGS. 1 to 5 for an exploded view, a perspective view and a sectional view of an inductive touch pen structure, and schematic views of the inductive touch pen held by a user's hand and not approaching and approaching a screen of an electronic product in accordance with the present invention respectively, the inductive touch pen structure is provided for the use by an electronic product 5 having a screen 51. In a preferred embodiment, the inductive touch pen structure comprises a main body 1, a pen clip 4, a touch head 2, at least one NFC module 3.

The main body 1 includes an upper casing 11 and a lower casing 12 coupled with each other, and the upper casing 11 is selectively a non-conductive upper casing 11 or a conductive upper casing 11; and the lower casing 12 is selectively a conductive lower casing 12 or a non-conductive lower casing 12.

The pen clip 4 is an elastic member installed on the main body 1, and an inner side of an end of the pen clip 4 is attached to the main body 1. In this preferred embodiment, the pen clip 4 is installed at the upper casing 11 of the main body 1. The invention is not limited to such arrangement only, but the pen clip 4 can also installed at the lower casing 12 of the main body 1.

The touch head 2 is installed on the upper casing 11 or the lower casing 12 of the main body 1. To achieve the same effect of touching the screen 51 of the electronic product 5 by the finger of a user' hand 6, the touch head 2 is installed at the conductive upper casing 11 or the conductive lower casing 12.

The at least one Near Field Communication (NFC) module 3 is a thin plate installed on the main body 1, and the NFC module 3 is installed at the non-conductive upper casing 11 or the non-conductive lower casing 12 to operate the electronic product 5 with the screen 51 by a high-frequency wireless communication technology.

Wherein, the electronic product 5 with the screen 51 includes but not limited to a mobile phone with the NFC function, a tablet PC with the NFC function, or any other electronic product 5 with the NFC function.

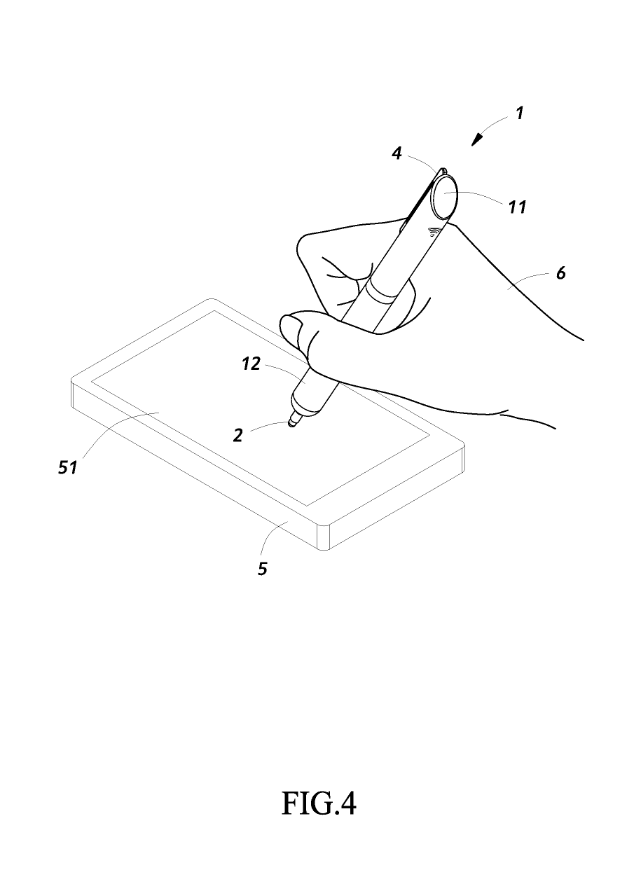

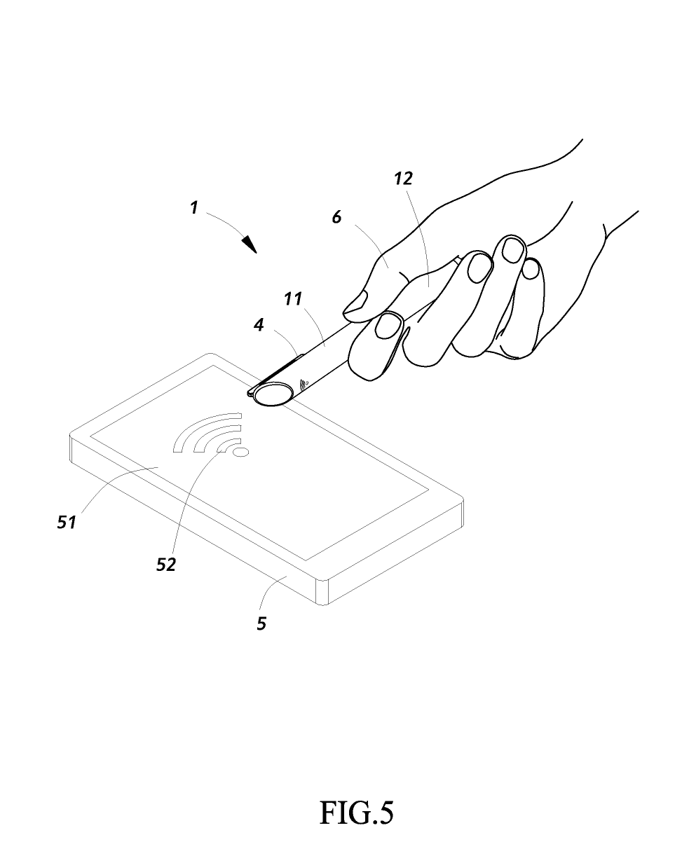

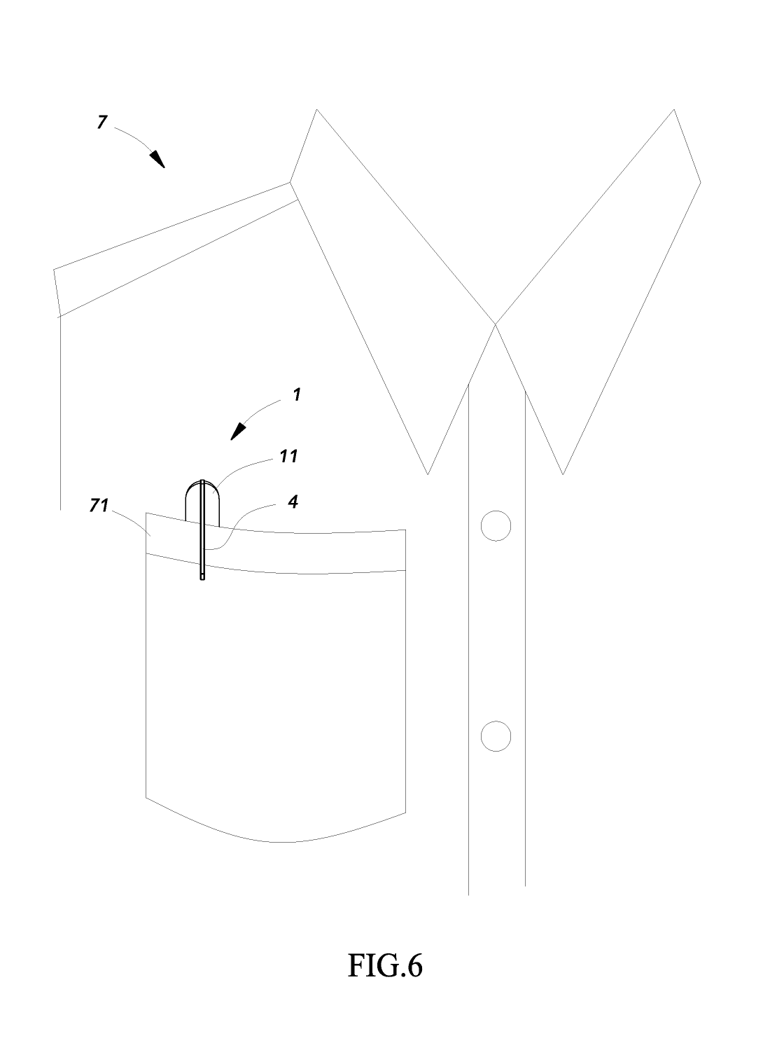

With reference to FIGS. 4, 5 and 6 for the schematic views of an inductive touch pen held by a user's hand and not approaching and approaching a screen of an electronic product, and a schematic view of a touch pen clipped onto a pocket of a user's clothes in accordance with the present invention respectively, the main body 1 with the NFC module 3 is held at a position near the screen 51 of the electronic product 5 with the NFC function by fingers of a user's hand 6. If the two are not disposed close to each other, the built-in application program of the electronic product 5 will not be opened, and no application program icon 52 will appear on the screen 51 (as shown in FIG. 4). If the two are disposed close to each other (but not in contact), the NFC module 3 of the main body 1 and the electronic product 5 with the NFC function can be used to open the built-in application program, and the application program icon 52 will appear on the screen 51 of the electronic product 5 (as shown in FIG. 5), wherein the page with the application program icon 52 required by the entry of the touch head 2 will be provided. When not in use, the touch pen of the present invention can be stored or clipped onto a pocket 71 of the user's by the pen clip 4 (as shown in FIG. 6) or clipped to any other position.

With this structure, the main body 1 with the NFC module 3 can use the high-frequency wireless communication technology to open the built-in application program of the electronic product 5 with the NFC function by a non-contact method, so as to improve the convenience of use, practicality, and user requirements effectively.

In summation of the description above, the present invention improves over the prior art, and is thus duly filed for patent application. While the invention has been described by means of specific embodiments, numerous modifications and variations could be made thereto by those skilled in the art without departing from the scope and spirit of the invention set forth in the claims.

What is claimed is:

1. An inductive touch pen structure, applied in an electronic product with a screen, comprising:
a main body, including an upper casing and a lower casing coupled with each other;
a touch head, selectively installed at an end of the upper casing or the lower casing of the main body;
at least one near field communication (NFC) module, being a thin plate installed on the main body.

2. The inductive touch pen structure of claim 1, wherein the main body further includes a pen clip which is an elastic member having an inner side of an end attached to the main body.

3. The inductive touch pen structure of claim 1, wherein the pen clip is disposed at the upper casing or the lower casing.

4. The inductive touch pen structure of claim 2, wherein the pen clip is disposed at the upper casing or the lower casing.

5. The inductive touch pen structure of claim 1, wherein the upper casing is a non-conductive upper casing or a conductive upper casing.

6. The inductive touch pen structure of claim 2, wherein the upper casing is a non-conductive upper casing or a conductive upper casing.

7. The inductive touch pen structure of claim 1, wherein the lower casing is a conductive lower casing or a non-conductive lower casing.

8. The inductive touch pen structure of claim 2, wherein the lower casing is a conductive lower casing or a non-conductive lower casing.

9. The inductive touch pen structure of claim 1, wherein the touch head is disposed at the conductive upper casing or the conductive lower casing.

10. The inductive touch pen structure of claim 2, wherein the touch head is disposed at the conductive upper casing or the conductive lower casing.

11. The inductive touch pen structure of claim 7, wherein the NFC module is installed at the non-conductive upper casing or the non-conductive lower casing.

12. The inductive touch pen structure of claim 8, wherein the NFC module is installed at the non-conductive upper casing or the non-conductive lower casing.

13. The inductive touch pen structure of claim 1, wherein the electronic product is a mobile phone with the NFC function, a tablet PC with the NFC function, or an electronic product with the NFC function.

14. The inductive touch pen structure of claim 2, wherein the electronic product is a mobile phone with the NFC function, a tablet PC with the NFC function, or an electronic product with the NFC function.
